(19) United States
(12) Patent Application Publication
(10) Pub. No.: US 2026/0161152 A1
(43) Pub. Date: Jun. 11, 2026

(54) BOOSTER PUMP CONTROL ALGORITHMS

(71) Applicant: Franklin Electric Co., Inc., Fort Wayne, IN (US)

(72) Inventors: Shawn Ellis Beverly, Fort Wayne, IN (US); Benjamin W. Schafer, Auburn, IN (US); Kevin Michael Fox, New Haven, IN (US); Adrian Chavis, Fort Wayne, IN (US); Matthew D. Rumple, Fort Wayne, IN (US); Amjad Masood, Fort Wayne, IN (US); Jeffrey Duane Wilder, New Haven, IN (US)

(21) Appl. No.: 19/410,114

(22) Filed: Dec. 5, 2025

Related U.S. Application Data
(60) Provisional application No. 63/728,788, filed on Dec. 6, 2024.

(51) Int. Cl. G05B 19/416

(52) U.S. Cl. CPC G05B 19/416; G05B 2219/43193

(57) ABSTRACT

Various systems and methods are provided for controlling a water pressure booster pump to (1) change operation during a future time period that may repeat on a weekly basis, (2) enter a sleep mode in response to no or low demand, (3) require a user to perform an unlock sequence to exit sleep mode, (4) preventing access to configure operating parameters of a pump until a user enters a password, (5) and configure a network of pumps for coordinated operation.

### CROSS REFERENCE TO RELATED APPLICATIONS

This application is related to U.S. Provisional Application Ser. No. 63/717,374 filed Nov. 7, 2024, and U.S. Provisional Application Ser. No. 63/717,394, filed Nov. 7, 2024, and claims priority to U.S. Provisional Application Ser. No. 63/728,788, entitled “BOOSTER PUMP CONTROL ALGORITHMS,” filed Dec. 6, 2024, the entire disclosures of which being hereby expressly incorporated by reference herein.

### FIELD OF THE DISCLOSURE

The present disclosure pertains to booster pumps, and more specifically to various aspects of controlling the operation of a booster pump.

### BACKGROUND

Residential water pressure may vary from place to place and time to time for a variety of reasons. Low water pressure, for example pressure below approximately 40 psi, may be frustrating for users of water delivery mechanisms such as shower heads, faucets, etc. Some low water pressure instances are a result of blockages or leaks in the plumbing of the residential structure. Other instances occur because the residential water source provides low water pressure. In these instances, one solution for the problem of low water pressure is a residential water pressure booster pump.

Generally speaking, water pressure booster pumps are installed in the home or garage and plumbed to the incoming main water source. The booster pumps include a pump that increases the pressure of the incoming water and one or more outlets that route the higher-pressure water to one or more water delivery mechanisms. Many such booster pumps can control the high-pressure water to a constant pressure, regardless of variations in the pressure of the main water source or variations in demand by the water delivery mechanisms.

Operating a booster pump has associated costs, such as the cost of the electrical power consumed by the pump. It is desirable to reduce the power consumption of the pump while maintaining a desired water pressure. It is also desirable to be able to configure the operation of the pump or a network of pumps such that it corresponds to the current or expected demand of the water consuming devices at the installation. In some circumstances, the operation of the pump may be limited, which not only reduces power consumption but may also extend the life of the pump. Finally, it is desirable to ensure that the operation parameters of the pump are only programmed and/or changed by authorized users.

### SUMMARY

In one embodiment, the present disclosure provides a method of controlling a water pressure booster pump, comprising: enabling a user to specify a future time period during which a processor controlling operation of a pump/motor assembly (“PMA”) of the pump causes a change in the operation of the PMA; enabling the user to specify the change in the operation of the PMA as one of operating the PMA at a temporary pressure setpoint or stopping operation of the PMA; controlling, by the processor, the operation of the PMA at an original pressure setpoint until a start time of the future time period occurs; controlling, by the processor, the operation of the PMA according to the user-specified change in operation of the PMA when the start time of the future time period occurs; and controlling, by the processor, the operation of the PMA at an original pressure setpoint when a stop time of the future time period occurs. In one aspect, enabling the user to specify the future time period includes enabling the user to select via an interface of the pump the start time including a start year, a start month and a start day, and the stop time including a stop year, a stop month and a stop day. A variant of this aspect further comprises determining, by the processor, whether the start time is before the stop time. In another aspect, enabling the user to specify the future time period includes enabling the user to select via an interface of the pump a number of days beginning with a current day. In another aspect, enabling the user to specify the change in the operation of the PMA includes enabling the user to specify that the temporary pressure setpoint for the PMA during the future time period will be a minimum pressure setpoint. Another aspect further comprises monitoring, by the processor, a demand for water during the future time period and transmitting a message via a communication circuit of the pump to the user in response to the demand exceeding the reduced pressure setpoint. Another aspect further comprises enabling the user to specify that the future time period corresponds to at least one scheduled event that occurs each week. In another aspect, enabling the user to specify the future time period includes enabling the user to select via an interface of the pump the start time including a start time of day and an end time of day. In another aspect, enabling the user to specify the change in the operation of the PMA includes enabling the user to specify that the temporary pressure setpoint for the PMA during the future time period will be an increased pressure setpoint relative to the original pressure setpoint. In another aspect, enabling the user to specify a future time period includes enabling the user to specify a plurality of future time periods, each future time period corresponding to at least one time period during each of a plurality of consecutive weeks.

In another embodiment, the present disclosure provides a method of controlling a water pressure booster pump, comprising: detecting, by a processor, a presence or an absence of flow data provided by a flow sensor in flow communication with an outlet of the pump; determining, by the processor in response to detecting a presence of flow data, whether the flow data is greater than zero, indicating a demand of water from the pump; responding, by the processor, to a determination that the flow data is not greater than zero, indicating no demand of water from the pump, by entering a sleep mode of operation wherein the processor causes a pump/motor assembly (“PMA”) of the pump to discontinue operation. One aspect further comprises: determining, by the processor when in the sleep mode of operation, whether the flow data is greater than zero, indicating a demand of water from the pump; and responding, by the processor, to a determination that the flow data is greater than zero by exiting the sleep mode of operation wherein the processor controls the PMA to provide water at a substantially constant pressure according to a pressure setpoint. Another aspect further comprises determining, by the processor in response to detecting an absence of flow data, whether pressure data provided by a pressure sensor in flow communication with the outlet of the pump indicates a pressure of water at the outlet that is less than a pressure threshold; controlling, by the processor, the PMA to provide water at a first pressure setpoint for a first time period, then controlling, by the processor, the PMA to provide water at a second, higher pressure setpoint for a second time period; and causing, by the processor, the pump to enter the sleep mode of operation in response to a frequency of operation of the PMA remaining below a frequency threshold for a third time period during the controlling step. In a variant of this aspect, the frequency of operation of the PMA is a frequency of operation of a variable frequency drive of a motor section of the PMA. In another aspect, determining, by the processor in response to detecting a presence of flow data whether the flow data is greater than zero is performed by the processor periodically.

In another embodiment, the present disclosure provides a method of controlling access to an interface of a water pressure booster pump, comprising: configuring the interface to enter a sleep mode of operation in response to an expiration of a period of time during which no user interaction with the interface occurs, wherein when in the sleep mode of operation a display of the interface is shut off; configuring the interface to exit the sleep mode of operation in response to a user touching one of a plurality of buttons on the interface, the plurality of buttons, when functional, enable the user to interact with the interface; disabling at least one of the plurality of buttons after exiting the sleep mode of operation until an unlock sequence is performed by the user using the plurality of buttons; and displaying on the display a message to the user to perform the unlock sequence to enable the at least one of the plurality of buttons that is disabled. In one aspect, the plurality of buttons includes a start/stop button, and disabling at least one of the plurality of buttons includes disabling all of the plurality of buttons except the start/stop button. In a variant of this aspect, the start/stop button enables the user to stop operation of the pump without performing the unlock sequence. In another aspect, the unlock sequence includes simultaneously activating at least two of the plurality of buttons for a predetermined period of time.

In yet another embodiment, the present disclosure provides a method of controlling access to an interface of a water pressure booster pump, comprising: configuring the interface to enter a sleep mode of operation in response to an expiration of a period of time during which no user interaction with the interface occurs, wherein when in the sleep mode of operation a display of the interface is shut off; configuring the interface to exit the sleep mode of operation in response to a user touching one of a plurality of buttons on the interface, the plurality of buttons, when functional, enable the user to interact with the interface; preventing access by the user to configure operating parameters of the pump after exiting the sleep mode of operation until a password is entered by the user using the plurality of buttons; and displaying on the display a message to the user to enter the password to enable the at least one of the plurality of buttons that is disabled. One aspect further comprises: displaying on the display a plurality of digits; responding to user activation of a first button of the plurality of buttons by one of incrementing or decrementing a first digit of the plurality of digits; and responding to user activation of a second button of the plurality of buttons by storing the one of the plurality of digits as a first entered digit of the password. Another aspect further comprises after storing the first entered digit, highlighting a next digit of the plurality of digits, responding to user activation of the first button by one of incrementing or decrementing the next digit, and responding to user activation of the second button by storing the next digit as a second entered digit of the password. Another aspect further comprises permitting access by the user to configure operating parameters of the pump upon entry by the user of an administrative password using a remote device in communication with the pump via a network.

In another embodiment, the present disclosure provides a method of controlling a water pressure booster pump, comprising: providing, via a first interface of a first pump, a network option enabling a user to establish a first pump network through interaction with the first interface; responding to the user selecting the network option by designating the first pump a lead pump role; responding to the user selecting the network option by broadcasting, via a communication circuit of the first pump, an invitation option to at least one second pump within range of the communication circuit to join the first pump network; providing, via an interface of the at least one second pump, a join option enabling the user to cause the at least one second pump to join the pump network; responding to the user selecting the join option by designating the at least one second pump a lag pump role; and controlling the first pump and the at least one second pump to operate together to provide pressurized water to at least one water consuming device. One aspect further comprises: providing, via the first interface, an alternation option enabling the user to selection an alternation mode of operation of the first pump and the at least one second pump; and responding to the user selecting the alternation option by causing the first pump and the at least one second pump to alternate operation. A variant of this aspect further comprises providing, via the first interface, an alternation timer option enabling the user to select, via the first interface, an alternation timer for alternating operation of the first pump and the at least one second pump. Another aspect further comprises: providing, via the first interface, an edit option enabling the user to edit parameters of an existing pump network; and responding to the user selecting the edit option by providing, via the first interface, an alternation mode option, an alternation time option and a pump role option. A variant of this aspect further comprises: responding to the user selecting the alternation mode option by providing the user an enable option and a disable option; responding to the user selecting the enable option by enabling an alternation mode of operation for pumps connected on the existing pump network; and responding to the user selecting the disable option by disabling the alternation mode of operation. Another aspect further comprises responding to the user selecting the alternation timer option by enabling the user to select, via the first interface, an alternation timer for alternating operation of pumps connected on the existing pump network. Another aspect further comprises responding to the user selecting the pump role option by providing the user a lead pump role option, a lag pump role option and a standby pump role option. A variant of this aspect further comprises responding to the user selecting the lead pump role option by designating the first pump the lead pump role in the existing network. Another aspect further comprises responding to the user selecting either of the lag pump role option or the standby pump role option by prompting the user to indicate whether the first pump currently has a lead pump designation. A variant of this aspect further comprises responding to an indication from the user that the first pump currently has the lead pump designation by prompting the user to change a designation of another pump in the existing pump network to the lead pump designation. Another variant further comprises: responding to an indication from the user that the first pump does not currently have the lead pump designation by prompting the user to select a lag pump designation for the first pump or a standby pump designation for the first pump; responding to the user selecting the lag pump designation by designating the first pump a lag pump role; and responding to the user selecting the standby pump designation by designating the first pump a standby pump role.

### BRIEF DESCRIPTION OF THE DRAWINGS

The above-mentioned and other advantages and objects of this invention, and the manner of attaining them, will become more apparent, and the invention itself will be better understood, by reference to the following description of embodiments of the invention taken in conjunction with the accompanying drawings, wherein:

FIG. 1 is a perspective view of a fully assembled water pressure booster pump according to one embodiment of the present disclosure;

FIG. 2 is a perspective view of the booster pump of FIG. 1 with the housing and the cover removed;

FIG. 3 is a schematic diagram of a communication system for the booster pump of FIG. 1;

FIG. 4 is a front view of an interface of the booster pump of FIG. 1;

FIG. 5 is a flow chart of a process for configuring a Vacation Mode of the booster pump of FIG. 1;

FIG. 6 is a flow chart of a process for configuring a Schedule Mode of the booster pump of FIG. 1;

FIG. 7 is a side cross-sectional view of the booster pump of FIG. 1;

FIG. 8 is a flow chart of a Sleep Mode algorithm for the pump of FIG. 1; and

FIGS. 9-12 are flow charts of a process for configuring a Multidrive feature of the booster pump of FIG. 1.

Corresponding reference characters indicate corresponding parts throughout the several views. Although the drawings represent embodiments of the present disclosure, the drawings are not necessarily to scale, and certain features may be exaggerated or omitted in some of the drawings in order to better illustrate and explain the present disclosure.

### DETAILED DESCRIPTION

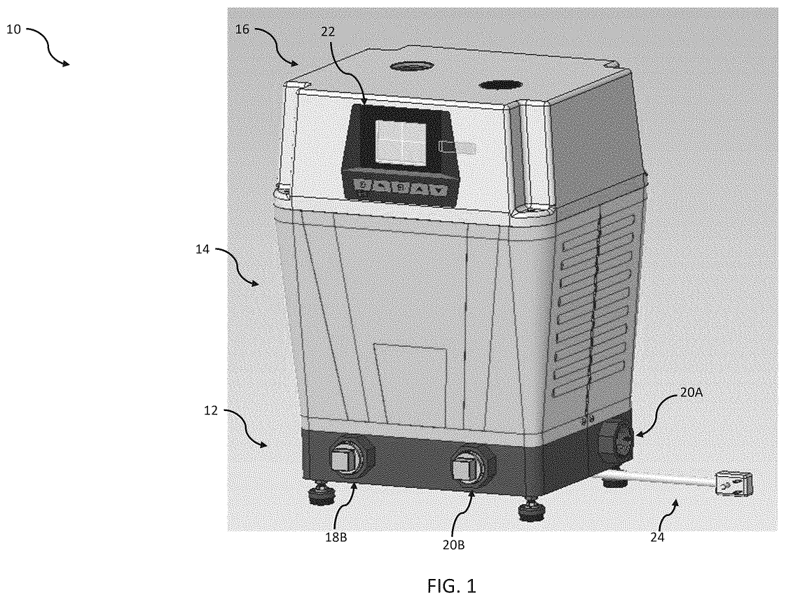

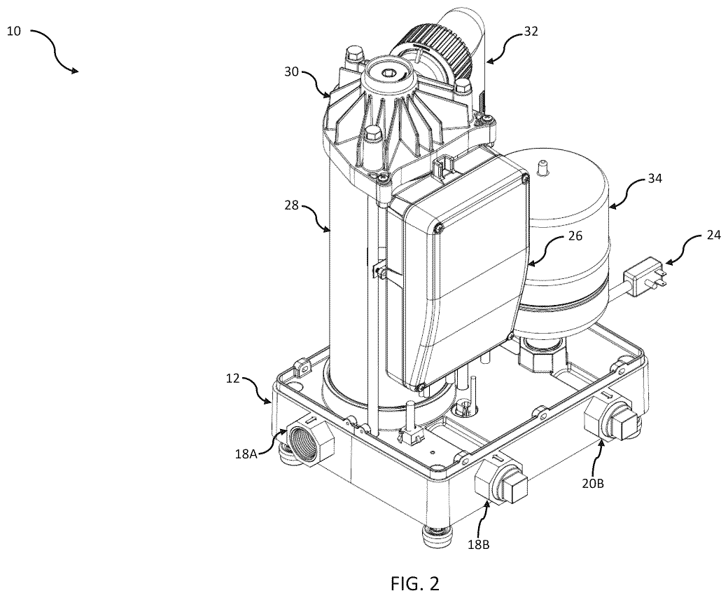

Referring now to FIGS. 1 and 2, a water pressure booster pump 10 according to one embodiment of the present disclosure is shown. Pump 10 generally includes a base 12, an outer housing 14 and a cover 16, as well as a plurality of internal components that will be described below. Further description of the pump 10 is provided in co-pending provisional application Ser. 63/717,374, titled “WATER PRESSURE BOOSTER,” filed on Nov. 7, 2024, the entire disclosure of which being expressly incorporated herein by reference. The base 12 includes two inlets 18A, 18B and two outlets 20A, 20B. The base 12 routes water from a water source connected to one of the inlets 18A, 18B through the internal components of the pump 10 where the pressure of the water is increased and to one of the outlets 20A, 20B for delivery to water consumption mechanisms connected to the selected outlet 20A, 20B. The internal components of the pump 10 are enclosed by the housing 14 which is mounted on the base 12 and the cover 16 which is mounted on the housing 14. The cover 16 supports an interface 22 which functions as a human-machine-interface (“HMI”) as is described in greater detail below. A power cord 24 is routed through the base 12 and the housing 14 to provide power to a drive box (described below) and the interface 22.

As best shown in FIG. 2 (showing the pump 10 of FIG. 1 with the cover 16 and the housing 14 removed), the internal components of the pump 10 include a drive box 26, a pump/motor shell 28, a discharge cover 30, a sensor pipe 32 and a pressure tank 34. A pump motor assembly (“PMA,” not shown) is enclosed within the pump/motor shell 28 and includes a motor that drives a pump assembly for pressurizing incoming water. The pump/motor shell 28 is connected to the base 12 and receives incoming water from one of the inlets 18A, 18B which fills a gap between the shell 28 and the PMA and flows into the pump assembly where it is pressurized. The upper end of the shell 28 (where the pump assembly is located) is connected to the discharge cover 30. Pressurized water from the pump assembly in the shell 28 flows into the discharge cover 30 and is routed through the discharge cover 30 to the sensor pipe 32. The pressurized water flows through the sensor pipe 32, where the pressure and flow rate of the water are measured by a pressure sensor and a flow sensor, respectively. The water then flows through the base 12 and out one of the outlets 20A, 20B for use by water delivery mechanisms connected by plumbing to the base 12. The pressure tank 34 is in flow communication with the pressurized water from the sensor pipe 32 and functions as an accumulator to smooth out pressure fluctuations in the outgoing water. In this manner, the pump 10 provides water to water delivery mechanisms at a substantially constant, increased pressure relative to the incoming water.

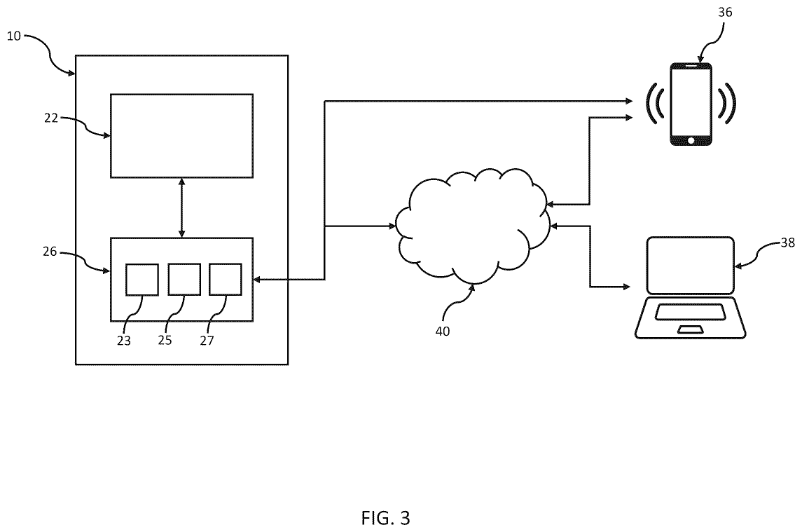

In certain embodiments, various features of the pump 10 may be configured using the interface 22 or using a remote device. Referring to FIG. 3, a simplified version of the pump 10 is shown with the interface 22 and the drive box 26. The drive box 26 is shown as including a processor 23, a memory 25 and a communication circuit 27. It should be understood that the drive box 26 includes a variety of other electronic components and functions as a controller for the interface 22 and a variable frequency drive for the PMA, as well as receiving pressure and flow signals from the sensors. The communication circuit 27 of the drive box 26 may be configured to communicate with a network 40, such as the Internet, via an intermediate WiFi connection to a router (not shown). The communication circuit 27 may also be configured to communicate via a Bluetooth connection to a remote device. In the example shown, the communication circuit 27 is configured to communicate with a smartphone 36 via the Bluetooth connection and/or the network 40. The communication circuit 27 is also shown configured to communicate with a computing device 38 such as a laptop or desktop computer. The smartphone 36 executes an application specifically designed to enable a user to configure the various features of the pump 10 described below using the smartphone 36. Similarly, the computing device 38 executes a program specifically designed to enable a user to configure the various features of the pump 10 described below using the computing device 38. As indicated above, however, a user may directly interact with the interface 22 to configure the functions of the pump 10 as described below.

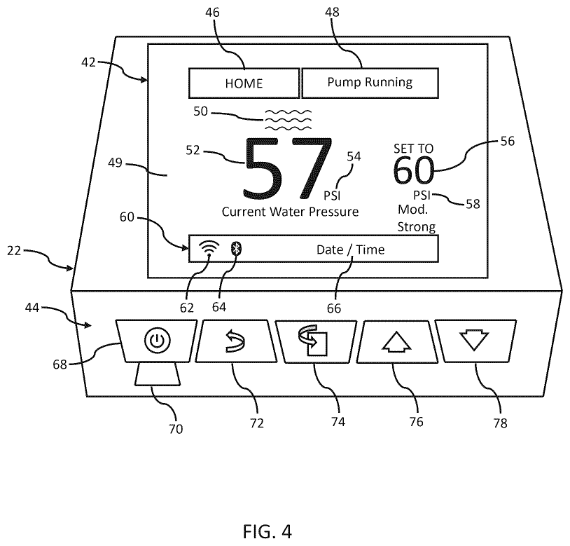

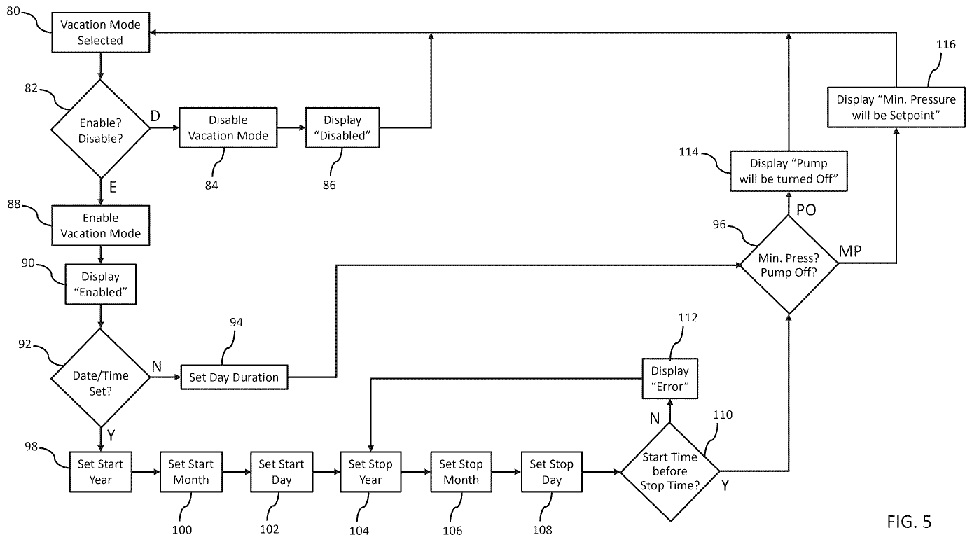

Referring now to FIG. 4, the interface 22 according to embodiments of the present disclosure is depicted in more detail. In the example shown, the interface 22 generally includes a display 42 and a control panel 44. The display 42 generally includes a screen ID area 46, a status area 48, a main area 49, and an information panel 60. The screen ID area 46 indicates to the user which of the various screens provided by the interface 22 is currently being displayed. In this example, the interface 22 is displaying the “Home” screen as indicated by the screen ID area 46. The status area 48 provides the user with one of a plurality of different status messages regarding the operation of the pump 10. In this example, the pump 10 is running as indicated by the message in the status area 48. The main area 49 provides the user with a variety of different types of information and/or instructions depending upon the currently displayed screen. In this example, the main area 49 of the Home screen includes a flow icon 50 which indicates that the motor of the PMA is running, an output water pressure measurement 52 indicating the current water pressure being outputted by the pump 10, a units area 54 indicating the units corresponding to the output water pressure measurement 52 using the currently enabled system of measurement, a pressure setpoint indicator 56 which indicates the current setpoint for the output pressure of the pump 10, and a units area 58 indicating the units corresponding to the setpoint indicator 56 using the currently enabled system of measurement. The information panel 60, in this example, includes a WiFi icon 62 which indicates that the WiFi connection of the communication circuit 27 is active, a Bluetooth icon 64 which indicates that the Bluetooth connection of the communication circuit 27 is active, and a date/time area 66 which provides the user with the current date and time.

The control panel 44 of the interface 22 includes a start/stop button 68 which is dedicated to starting the pump 10 when it is not running and stopping the pump 10 when it is running. The control panel 44 also includes a power cycle icon 70 which turns power to the pump 10 on and off. The control panel 44 further includes a back button 72 which enables the user to navigate to a previously active menu option, screen, etc., an enter button 74 which enables the user to either move forward to a next menu option, screen, etc. or select a highlighted menu option, depending upon the context, and an up button 76 and a down button 78 which enable the user to scroll or increment up or down, respectively, in a displayed menu.

### Vacation Mode

By using the interface 22 or interacting with the drive box 26 using the smartphone 36 or the computing device 38, the user can configured the pump 10 to either shut down or operate at a minimum “safe” pressure for a time range in the future such as when the user, for example, will be on vacation or living in a seasonal home, and not at the location of the pump 10 to use the pressurized water provided by the pump 10. This feature, “Vacation Mode,” reduces water and power usage and provides a cost savings to the user in addition to extending the life of the pump 10. When in the Vacation Mode, the pump 10 is also configured in certain embodiments to monitor water flow and/or water pressure demand and send alert messages via the communication circuit 27 over the network 40 to the smartphone 36 or computing device 38 of the user. As is further described below, the alert messages may indicate to the user that the pump 10 is malfunctioning, the plumbing to or from the pump 10 is damaged (e.g., leaking), or one or more water consuming devices connected to the pump 10 is malfunctioning.

Referring now to FIG. 4, in certain embodiments, the user manually configures the pump 10 to enter the Vacation Mode by setting a start date and end date or a duration of days. In certain embodiments, the Vacation Mode is disabled by default. The following description assumes that the user is configuring the Vacation Mode using the interface 22. It should be understood, however, that the user may also configure the Vacation Mode using the smart phone 36 or the computing device 38. The process begins at block 80, where the user selects the Vacation Mode from a plurality of feature setup options displayed by a setup screen of the interface 22. The main area 49 of the display 42 displays a message to the user asking whether the Vacation Mode should be enabled or disable as indicated by block 82. The user selects one of these options by highlighting the selected option using the up button 76 or the down button 78 and choosing the highlighted option by pressing the enter button 74. If the user selects the disable option, the processor 23 sets a Vacation Mode parameter stored in the memory 25 to “disabled” as indicated by block 84 and causes a message such as “Vacation Mode is now disabled” to be displayed in the main area 49 of the display 42 as indicated by block 86. The process then returns to block 80.

If, on the other hand, the user selects the enable option, the processor 23 sets the Vacation Mode parameter to “enabled” as indicated by block 88 and causes a message such as “Vacation Mode is now enabled” to be displayed in the main area 49 of the display 42 as indicated by block 90. Next, as part of the process for enabling the Vacation Mode, the processor 23 determines whether the current date and time have previously been set by the user at block 92. If so, then the user can begin the process of selecting a future date range for the Vacation Mode as described below. If the current date and time have not previously been set, then the processor 23 causes the display 42 to provide an incrementable number of days, beginning with the current day, for the Vacation Mode to be active as indicated by block 94. The user may use the up button 76 and the down button 78 to change the number of days and the enter button 74 to select the number of days set by the user. After setting and selecting the number of days for Vacation Mode, the user is presented with a message asking whether the pump 10 should be turned off during Vacation Mode or set to provide a minimum “safe” pressure as indicated by block 96.

As indicated above, if the processor 23 determines at block 92 that the current date and time are set, then the processor 23 next causes the display 42 to display a message asking the user to set the year when Vacation Mode should become active as indicated by block 98. The user sets the start year using the up button 76, the down button 78 and the enter button 74 as described above. In certain embodiments, the default start year displayed is the current year. Next, the user sets the start month (block 100), the start day (block 102), the stop year (block 104), the stop month (block 106) and the stop day (block 108) by interacting with the display 42 using the up button 76, the down button 78 and the enter button 74 as described above. In certain embodiments, the default start month and default start day are the current month and the current day, respectively. In certain embodiments, the default stop year and the default stop month are the current year and the current month, respectively. The default stop day may be the current day plus one day. After the user has completed the process of setting the start year, month and day and the stop year, month and day, the processor 23 determines at block 110 whether the start time for the Vacation Mode is before the stop time. If the user erroneously sets the stop time to a year, month and day that is before or on the start time, the processor 23 causes the display 42 to display an error message to the user such as “Please set stop time to a date after the start time,” as indicated by block 112. The process then returns to block 104 where the user is prompted to re-enter the stop year, and proceeds through block 106, 108 and 110 as described above. If the start time is determined by the processor 23 to be before the stop time at block 110, the processor 23 causes the display 42 to present the message asking the user whether the pump 10 should be turned off during Vacation Mode or set to provide a minimum “safe” pressure as described above with reference to block 96.

If the user selects the option of turning the pump 10 off during Vacation Mode using the buttons 74, 76 and 78, then at block 114 the processor 23 causes the display 42 to display a message such as “Pump will be turned Off during Vacation Mode,” and the process returns to block 80 where the user may exit the process via a set up menu. When the start time for operation in Vacation Mode occurs, the processor 23 will cause the PMA 150 to stop operating. Similarly, if the user selects the option of setting the pump 10 to a minimum pressure during Vacation Mode using the buttons 74, 76 and 78, then at block 116 the processor 23 causes the display 42 to display a message such as “Pump will be set to minimum pressure during Vacation Mode,” and the process returns to block 80 where the user may exit the process via a set up menu. In certain embodiments, the default minimum pressure setting is 20 psi (1.4 bar). When the start time for operation in Vacation Mode occurs, the processor 23 will cause the PMA 150 to operate in a manner that pressurizes the water to a minimum pressure. In certain embodiments, at the end of the Vacation Mode (i.e., when the stop time arrives), the pump 10 resumes normal functioning and the drive box 26 sets the pressure setpoint to its previous value. While the pump 10 is operating in Vacation Mode, a Vacation Mode icon may be displayed in the main area 49 of the display 42, for example, in the location of the flow icon 50 depicted in FIG. 4. As indicated above, it should be understood that in certain embodiments, the user may navigate the Vacation Mode process remotely using the smartphone 36 and/or the computing device 38 rather than directly interacting with the interface 22.

In certain embodiments, the pump 10 detects the occurrence of water pressure or flow demand above the minimum pressure set for Vacation Mode. If such an event occurs, which may indicate a leak or malfunction in the pump 10, plumbing or devices connected to the pump 10, the communication circuit 27 may send an alert message via the network 40 to the smartphone 36 or computing device 38 of the user. The alert messages may indicate to the user that the pump 10 is malfunctioning, the plumbing to or from the pump 10 is damaged (e.g., leaking), or one or more water consuming devices connected to the pump 10 is malfunctioning.

### Schedule Mode

In certain embodiments, the Schedule Mode allows the user to create a plurality of weekly scheduled events (e.g., up to four events). Each scheduled event can be a scheduled stop/start time (standby mode) or a scheduled water pressure setpoint change, or both for a user-defined time period.

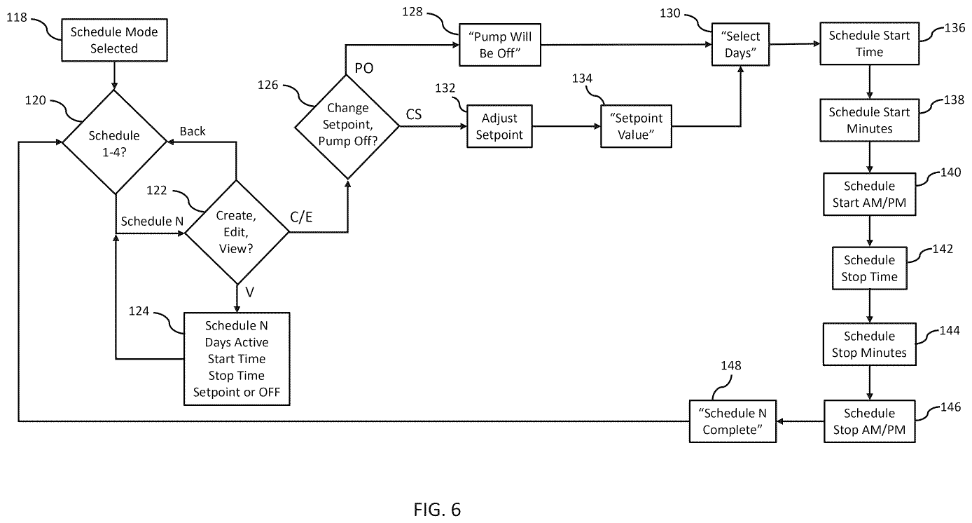

Referring to FIG. 6, by using the interface 22 or interacting with the drive box 26 using the smartphone 36 or the computing device 38, the user can configure the pump 10 to perform a plurality of scheduled events such as operating at a different pressure setpoint for a predetermined period of time or shutting down for a predetermined period of time. It should be understood that other types of scheduled events may be programmed. The user enters the Schedule Mode by selecting it from a main menu as indicated by block 118. The display 42 then presents the user with a plurality of scheduled event indictors such as Schedule 1, Schedule 2, Schedule 3 and Schedule 4 as indicated by block 120. Throughout the Schedule Mode process, the user may navigate through options using the up button 76 and the down button 78 on the control panel 44 of the interface 22 and select options using the enter button 74. The user may also go back to a previously displayed menu using the back button 72. The user may use these buttons to select a scheduled event at block 120.

After the user selects the scheduled event, the processor 23 causes the display 42 to present the user with the options of creating/editing the scheduled event or viewing details of the scheduled event (i.e., if the scheduled event was previously programmed) as indicated by block 122. If the user decides to switch to a different scheduled event, the user may use the back button 72 to return to block 120 to select a different scheduled event. Alternatively, the user may select the view option at block 122 whereupon, at block 124, the processor 23 will cause the display 42 to display information about the scheduled event, including the event number, the number of days the event is active, the start time, the stop time and the temporary pressure setpoint for the scheduled event or an indicator that the pump 10 will be shut off during the scheduled event, whichever was programmed. After the user views this information, the user may use the back button 72 to return to block 122.

If instead the user selects the create/edit option at block 122, the processor 23 causes the display 42 to present the user with the options of setting a temporary pressure setpoint for the scheduled event or shutting the pump 10 off during the scheduled event as indicated by block 126. If the user selects the pump off option at block 126, then the processor 23 causes the display 42 to display a message such as “Pump will turn Off” for a short time (e.g., 2-5 seconds) at block 128 then proceeds to block 130. If the user selects the change setpoint option at block 126, then, at block 132, the processor 23 causes the display 42 to display the current pressure setpoint and a message instructing the user to use the up button 76 and the down button 78 to increase or decrease the pressure setpoint for the scheduled event, and to use the enter button 74 to proceed. The adjusted temporary pressure setpoint for the scheduled event is stored in the memory 25 of the drive box 26. Then, at block 134 the processor 23 causes the display 42 to display the temporary pressure setpoint along with a message such as “Temporary Water Pressure Setpoint” for a short period of time (e.g., 2-5 seconds) before proceeding to block 130.

At block 130, the processor 23 causes the display 42 to present the user with a menu of “Select Days” options for the scheduled event. The options may include all week (i.e., the scheduled event is performed every day of the week), weekdays (i.e., the scheduled event is performed only on Mondays through Fridays), weekends (i.e., the scheduled event is performed only on Saturday and Sunday), and individual day options of Monday through Sunday if the scheduled event is to be performed every week but only on one or more selected days. The user navigates the menu using the up button 76 and the down button 78 to highlight the Select Days option(s) that should apply to the scheduled event. When that is complete, the user may select a “finished” or “next” option to cause the process to proceed to block 136. At block 136, the processor 23 causes the display 42 to present the user with a list of hours (1 thought 12) to select as the starting hour for the scheduled event. Then, at block 138 the user is presented with a list of starting minute options (e.g., 00, 15, 30, 45) for the scheduled event. At block 140, the user is presented with the options of setting the scheduled event to start before midday (i.e., AM) at the selected start hour and start minute or after midday (i.e., PM) at the selected start hour and start minute. After the user selects a start AM/PM option, the user sets the time for stopping the scheduled event (i.e., hour, minute, AM/PM) at blocks 142, 144 and 146 in the manner described above. Finally, at block 148, the processor 23 causes the display 42 to display a message such as “Schedule N is complete” for a short time (e.g., 2-5 seconds) and the process returns to block 120 where the user may select another scheduled event to create/edit or view.

As should be understood from the foregoing, the user may use the Schedule Mode for a variety of reasons. The user may wish to reduce power consumption of the pump 10 by setting a scheduled event every day that causes the pump 10 to shut off during the user's normal sleeping hours. The user may also wish to increase the water pressure from the pump 10 during the scheduled regeneration cycles of a water softener connected to the pump 10. After any such scheduled event, the pump 10 returns to its normal operation mode until another scheduled event occurs. It should also be understood that in certain embodiments, the user may navigate the Schedule Mode process remotely using the smartphone 36 and/or the computing device 38 rather than directly interacting with the interface 22. Additionally, in certain embodiments the Schedule Mode and any of the other configuration processes described herein may include a time-out feature such that if a particular action is not completed by the user for a relatively long period of time (e.g., 5 to 10 minutes), the process is exited and the display 42 returns to the Home screen.

### Sleep Mode

The pump 10 of the present disclosure further includes a Sleep Mode feature which reduces the power consumption of the pump 10 by shutting it down during period of no demand, which in turn may reduce the cost of operating the pump 10 and increase the life of the pump 10. Generally, when the water consuming devices connected to the pump 10 are not consuming water (e.g., are shut off), the pump 10 does not need to pressurize water and can shut down until demand for water resumes.

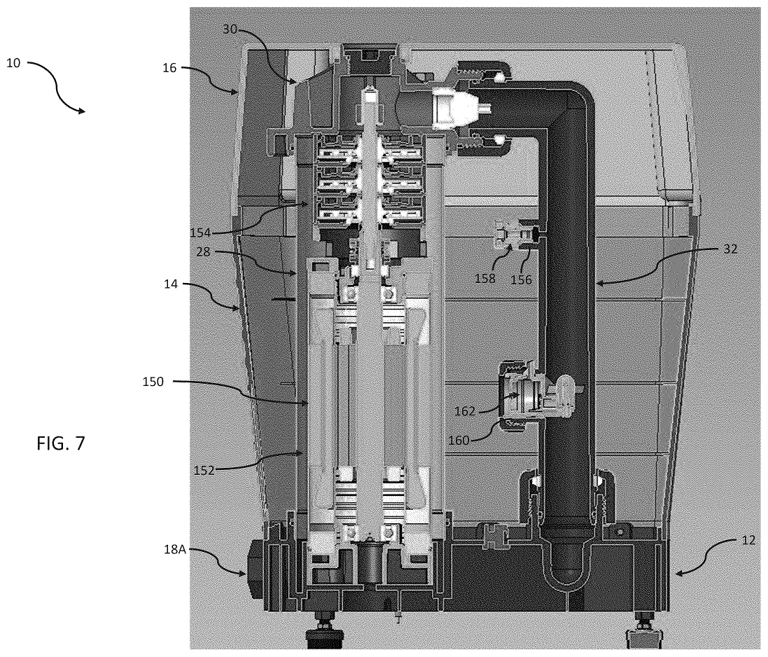

Referring now to FIGS. 2 and 7, the PMA 150 is shown enclosed within the pump/motor shell 28. The PMA 150 includes a motor section 152 that drives a pump assembly 154 which provides pressurized water through the discharge cover 30 to the sensor pipe 32. In certain embodiments, the sensor pipe 32 includes a pressure port 156 configured to receive a pressure sensor 158 and a flow port 160 configured to receive a flow sensor 162. The pressure sensor 158 detects the pressure of water in the sensor pipe 32 and provides pressure measurement signals to the drive box 26. Similarly, the flow sensor 162 measures the flow of water through the sensor pipe 32 and provides flow measurement signals to the drive box 26. The processor 23 of the drive box 26 operates a variable frequency drive (“VFD”) in the drive box 26 to control operation of the motor section 152, which controls operation of the pump assembly 154 to achieve a desired water pressure. In this manner, the pump 10 provides water to water delivery mechanisms of a substantially constant, increased pressure relative to the incoming water.

In operation, the processor 23 controls operation of the VFD to provide water at a desired pressure setpoint regardless of demand fluctuations based on the flow measurements from the flow sensor 162, measurements of the speed (i.e., frequency) of operation of the motor section 152 and pressure measurements from the pressure sensor 158. When demand is satisfied or is zero, the processor 23 periodically determines whether the PMA 150 can be turned off (i.e., enter the Sleep Mode) to conserve energy and prolong the life of the pump 10 as is further described below. In certain embodiments, as described below, the processor 23 may cause the PMA 150 to enter the Sleep Mode based on the flow measurements from the flow sensor 162 unless such flow measurements are unavailable, in which case the processor 23 may cause the PMA 150 to enter the Sleep Mode based on the pressure measurements from the pressure sensor 158 and the frequency of operation of the VFD of the motor section 152.

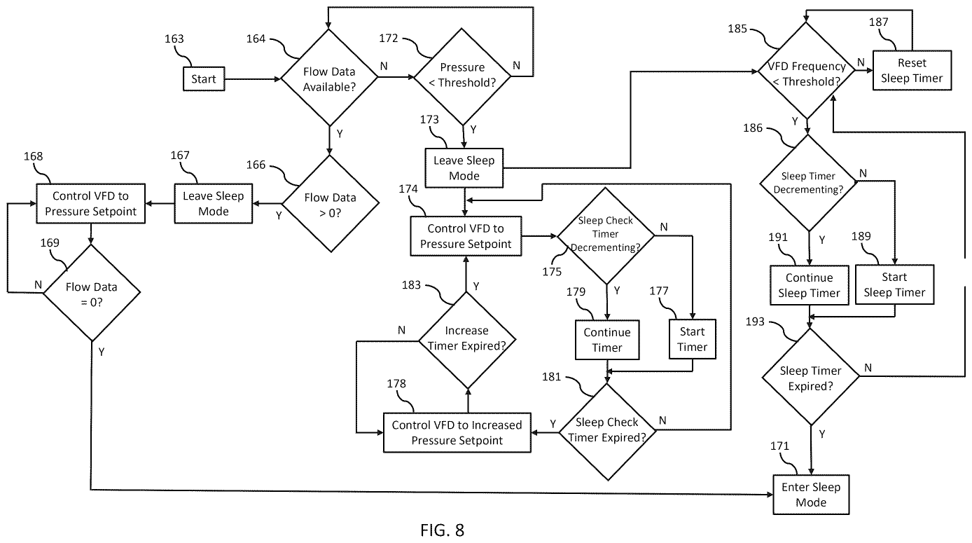

Referring now to FIG. 8, a Sleep Mode process is depicted in flow chart form. During normal operation of the pump 10, the processor 23 periodically determines whether to cause the PMA 150 to enter the Sleep Mode by evaluating the flow measurements from the flow sensor 162. In certain embodiments, the processor 23 performs the Sleep Mode determination every 10 seconds. The process begins at block 163. At block 164, the processor 23 determines whether flow measurement data is available. In some cases, the pump 10 is not equipped with a flow sensor 162, so flow measurement data is not available. In other instances, the flow sensor 162 may be malfunctioning, so flow measurement data is not available. If, however, flow measurement data is available, the processor 23 determines whether the data indicates a flow that is greater than zero at block 166. Flow measurement data greater than zero indicates that water is flowing through the sensor pipe 32 in response to demand for water from the pump 10. Thus, if the flow measurement data is greater than zero, then at block 167 the processor 23 causes the pump 10 to exit the Sleep Mode if the pump 10 was previously in the Sleep Mode. Next, the processor 23 controls the VFD in a normal manner to control the pressure of the water output from the pump to the pressure setpoint as indicated by block 168. At block 169 the processor 23 determines whether the flow measurement data indicates that the flow is equal to zero. If not, then the processor 23 continues controlling the VFD in a normal manner at block 168. If, however, the flow data equals zero, then the processor 23 causes the pump 10 to enter the Sleep Mode at block 171. In other words, the processor 23 causes the motor section 152 to stop driving operation of the pump assembly 154 of the PMA 150.

In cases where flow measurement data is not available at block 164 (e.g., a missing or malfunctioning flow sensor 162), the processor 23 determines at block 172 whether the pressure measurements from the pressure sensor 158 are less than a predetermined threshold pressure (e.g., setpoint pressure minus 5 PSI). If not, then the process returns to block 164 and the processor 23 continues (1) determining whether flow data is available and (2) monitoring the pressure measurements. If the pressure measurements from the pressure sensor 158 fall below the predetermined threshold pressure, then the processor 23 causes the pump 10 to exit the Sleep Mode at block 173.

After exiting the Sleep Mode, the processor 23 performs two loops in parallel. In the first loop, the processor 23 controls the VFD in a normal manner to maintain the pressure setpoint as indicated by block 174. The processor 23 then determines, at block 175, whether a sleep check timer is decrementing. If not, then the processor 23 starts the sleep check timer at block 177. If the timer is decrementing, then the processor 23 continues decrementing the timer at block 179. At block 181 the processor 23 determines whether the sleep check timer has expired. If not, then the process returns to block 174 where the processor 23 controls the VFD in a normal manner to maintain the pressure setpoint. If the timer has expired, however, then the processor 23 controls the VFD to an increased pressure setpoint such as 3 PSI above the pressure setpoint as indicated by block 178. Next, at block 183, the processor 23 determines whether an increase timer has expired. In certain embodiments, the increase timer is approximately 10 seconds. If not, then the process returns to block 178. If the increase timer has expired, then the process returns to block 174 and the processor 23 controls the VFD in a normal manner to maintain the pressure setpoint.

In the second loop after leaving the Sleep Mode at block 173, the processor 23 determines at block 185 whether the monitored operating frequency of the VFD falls below a predetermined threshold frequency (e.g., the minimum operating frequency plus 1 Hz). If not, then the processor 23 resets the sleep timer at block 187 and the process returns to block 185. If the monitored operating frequency falls below the threshold, then at block 186 the processor 23 determines whether the sleep timer is decrementing. If not, then at block 189 the processor 23 starts the sleep timer. If the timer is decrementing, then at block 191 the processer 23 continues decrementing the sleep timer. At block 193, the processer 23 determines whether the sleep timer has expired. If not, then the process returns to block 185 where the processer 23 again monitors the operating frequency of the VFD to determine whether it falls below the predetermined threshold frequency. If, however, the sleep timer has expired, then the processer 23 causes the pump 10 to enter the Sleep Mode at block 171.

When in the Sleep Mode, the pump 10 wakes up if the processor 23 receives flow measurements from the flow sensor 162 that indicate that flow is greater than zero. At that point, the processor 23 causes the motor of the motor section 152 to begin operating.

In various embodiments of the present disclosure, the processor 23 may monitor the sleep mode operation of the pump 10 along with, for example, the output pressure and pump speed, to identify certain operational characteristics which may indicate faults, anomalies or other characteristics of the pump 10. For example, the processor 23 may determine the typical time between sleep modes by monitoring the sleep mode cycles of the pump 10 over time. If the pump 10 remains active for an unusually long period of time relative to the typical time between sleep modes, then there may be an anomaly in the pump operation. In one example, the unusually long time period may be, for example, 20 minutes. However, this time period may be longer or shorter depending upon the installation characteristics. If the pump 10 remains active for an unusually long time period, then the processor 23 may cause the pump 10 to enter a standby mode and send an alert or message to the user as described above.

In other alternative embodiments, the processor 23 may determine from the sleep mode pattern of the pump 10 that the pump 10 may be incorrectly sized or tuned. A pump that is oversized for the installation may turn on to satisfy demand, then quickly enter the sleep mode. For example, if the pump 10 enters the sleep mode too frequently (i.e., has a high sleep mode cycle time) over a period of time, the pump 10 may be too large for the installation or improperly tuned (i.e., the sleep mode parameters may be incorrect). In response to identifying such a high sleep mode cycle time, the processor 23 may send an alert or message to the user as described above.

In still other embodiments, the processor 23 may determine from the sleep mode pattern of the pump 10 and the output pressure that a leak or other anomaly is present, such as an unusually high demand in the system. For example, a slowly decaying pressure at the outlet of the pump 10 when the pump 10 is off (i.e., in sleep mode) may indicate a leak. Such a leak would result in the pump 10 repeatedly entering the sleep mode, exhibiting a slowly decaying pressure during each sleep mode. If the processor 23 identifies this behaviour, the processor 23 may send an alert or message to the user as described above.

In related embodiments, the processor 23 may identify a leak or other failure in the tank 34 of the pump 10 using the sleep mode pattern of the pump 10. For example, if the bladder of the tank 34 fails, the capacitor function of the tank 34 will be degraded, which could cause an anomalous sleep mode pattern that can be detected by the processor 23. In response to identifying such a condition, the processor 23 may send an alert or message to the user as described above.

Also, the processor 23 may monitor the number of times the pump 10 has entered the sleep mode over the entire operating life of the pump 10. Each time the pump 10 is activated and enters the sleep mode, the tank 34 is cycled. Through testing, the typical maximum number of tank 34 cycles may be determined. If the monitored number of tank 34 cycles exceeds the maximum number, the processor 23 may send an alert or message to the user as described above, indicating that tank 34 maintenance is recommended.

### Child Lock

Another feature of the pump 10 of the present disclosure is a screen lock feature which prevents unauthorized individuals (e.g., children) from accidentally or inadvertently changing the system parameters of the pump 10. This Child Lock feature, when enabled, prevents user interaction with the interface 22 until the user performs a multi-button unlock sequence using the buttons on the control panel 44 of the interface 22. When the interface 22 is inactive for a certain period of time, it enters a sleep mode wherein the display 42 is shut off. The interface 22 wakes up when a user touches one of the buttons on the control panel 44. If the Child Lock feature is enabled, when the interface 22 wakes up, none of the buttons on the control panel 44 (except the start/stop button 68, as described below) are functional until the multi-button unlock sequence is performed by the user. The display 42 may display a message to the user such as “Please perform the unlock sequence.” In one embodiment, the multi-button unlock sequence requires the user to simultaneously press the back button 72 and the down button 78 and hold the buttons for a predetermined period of time such as 3 to 5 seconds. After performing the unlock sequence, the user may interact with the interface 22 normally. When the interface 22 returns to the sleep mode, the Child Lock feature is again active such that the user must again perform the unlock sequence when the interface 22 next exits the sleep mode. In certain embodiments, a lock symbol may be displayed on the Home screen such as in the main area 49 in the location of the flow icon 50 as shown in FIG. 4.

As indicated above, even when the Child Lock feature is enabled and the interface 22 is locked, the user may use the start/stop button 68 to stop operation of the pump 10 without performing the unlock sequence. However, the user cannot restart the pump 10 using the start/stop button 68 without first performing the unlock sequence described above. In certain embodiments, the Child Lock feature may be enabled or disabled by the user from a settings menu available through the Home screen. In certain embodiments, the default setting for the Child Lock feature is disabled.

### Password

In certain embodiments of the pump 10 according to the present disclosure, a Password feature may be including instead of or in addition to the Child Lock feature. The Password feature provides the user with the ability to configure a Password to prevent unauthorized users from changing the operating parameters of the pump 10. In certain embodiments, the operating parameters of the pump 10 may also be accessed using a Mater Password in instances where the Password configured by the user is lost or forgotten. In other embodiments, the operating parameters of the pump 10 may also be accessed using an Administrator Password which provides the user the ability to lock out the functionality of the Password and the Master Password remotely as an override in instances where the Password and the Master Password were compromised and known by unauthorized users.

The Password feature generally prevents a user from changing operating parameters of the pump 10 until a Password is entered using the interface 22, the smartphone 36 and/or the computing device 38. The Password feature may be enabled by the user by selecting appropriate options from a Settings menu accessible via the Home screen displayed on the display 42 of the interface 22. In certain embodiments, default setting for the Password feature is disabled. If the Password feature is enabled, then when the pump 10 transitions from a sleep mode the processor 23 causes the interface 22 to display the Home screen with a message in the main area 49 of the display 42 such as “Enter passcode to unlock.” Along with the message, a row of four numerical digits is displayed, with the first digit highlighted. In certain embodiments the default row of numerical digits is “0000.” In other embodiments, more or fewer digits may be used.

The user may change the highlighted first digit to correspond to the first digit of the Password by using the up button 76 or the down button 78. When the displayed first digit matches the first digit of the Password, the user may press the enter button 74 on the control panel 44 of the interface 22 (FIG. 4) to select the digit. The processor 23 causes the next digit in the row to be highlighted. The process is repeated until the user has entered all four digits. If the processor 23 determines that all four entered digits match the previously stored Password, then the processor 23 causes the interface 22 to display the Home screen such as is depicted in FIG. 4 and the user may interact with the interface 22 in a normal manner. If, on the other hand, the one or more of the entered digits do not match the stored Password, then the processor 23 causes the interface 22 to display a message such as “Password incorrect.” The processor 23 then causes the interface 22 to return to the Home screen with the Password unlock message described above. In certain embodiments, the Home screen with the Password unlock message may include a Password locked icon in the main area 49 of the display 42 when the Password feature is enabled and the pump 10 is locked. In certain embodiments, the Home screen depicted in FIG. 4 may display a Password unlocked icon in the main area 49 of the display 42 when the Password feature is enabled and the pump 10 is unlocked. In certain embodiments, when the Password feature is enabled and the display 42 goes to sleep (e.g., after a period of inactivity such as 20 seconds), the Password feature returns to the locked state.

When the Password feature is changed from disabled to enabled by the user, the processor 23 causes the interface 22 to display a screen prompting the user to enter a Password in the manner described above. When the Password is entered, in certain embodiments, the processor 23 causes the interface 22 to display a verification message including the Password and verification options of “Yes” or “No.” The user may use the up button 76, the down button 78 and the enter button 74 in the manner described above to select a verification option. If the user enters the “No” verification option, then the processor 22 may cause the interface 22 to return to the screen described above prompting the user to enter a Password. If the user enters the “Yes” verification option, then the processor 22 stores the entered Password in the memory 25 and enables the Password feature.

In certain embodiments, the start/stop button 68 on the control panel 43 may still function to permit the user to stop operation of the pump 10 when the Password feature is enabled and locked. However, the user will not be able to restart the pump 10 using the start/stop button 68 until the Password feature has been unlocked by entering the correct Password as described above. In certain embodiments, the start/stop button 68 will not function at all (i.e., will not start or stop the pump 10) when the Password Override feature is enabled as described below.

In certain embodiments, a Master Password feature may be hardcoded in the pump 10 and written in the Owner's Manual for the pump 10. The Master Password will allow the user to activate the pump 10 in the manner described above in the event the user forgets the Password initially entered as described above. When the user enters the Master Password, the processor 23 may, in certain embodiments, cause the interface 22 to display the screen described above prompting the user to enter a new Password or disable the Password feature.

In certain embodiments, if the application running on the smartphone 36 successfully connects to the drive box 26 and the Password feature is enabled, the user will not be required to enter the Password to interact with the pump 10 via the smartphone 36. In certain embodiments, the user may change the Password using the application on the smartphone 36 even if the Password feature is already enabled and active on the pump 10.

In certain embodiments, the application running on the smartphone 36 (or the program running on the computing device 38) may include an option for the user to set up an Administrator Password. The Administrator Password, when enabled, may override the user Password and the Master Password. As such, changes to the parameters/features of the pump 10 can only be made using the application/program.

### Multidrive

In certain embodiments, the pump 10 may include a feature which allows multiple pumps 10 to operate together to satisfy a wider range of flow demands than a single pump 10 could satisfy. This Multidrive feature may, in certain embodiments, provide wireless interaction between up to eight pumps 10 to ensure that a desired pressure setpoint is maintained over the full flow range for the installation. In other embodiments, more or fewer than eight pumps 10 may be enabled to interact. In certain embodiments, the Multidrive feature may be configured by the user via either an Easy mode, which minimizes the required user input to setup a multi-pump system, or an Advanced mode, which provides more options and control to the user when setting up a multi-pump system, as is further described below. In certain embodiments, the Multidrive feature may be setup using the smartphone 36 and a Bluetooth connection to the drive box 26.

In certain embodiments, the Easy mode setup for the Multidrive feature assigns a Lead Pump designation to the first pump 10 put into the Multidrive setup mode. As the user adds additional pumps 10 to the Multidrive feature, each additional pump 10 will be assigned a Lag Pump designation. In certain embodiments, up to seven Lag Pumps may be added to the system. In certain embodiments, the Lead Pump is the only pump 10 in the system which can set various parameters for all pumps in the system, including but not limited to the water pressure setpoint, the drawdown pressure setpoint, the alternation timer, the lag start/stop speed, and timer delays. The timer delays may include a lag start delay of approximately 20 seconds and a lag stop delay of approximately 20 seconds. In certain embodiments, the Lead Pump will set the water pressure setpoint for each Lag Pump to a value that is lower than or equal to the water pressure setpoint of the Lead Pump. The Lead Pump may set the drawdown pressure setpoint to the same value for all pumps 10 in the system. In certain embodiments, the pumps 10 alternate operation from the Lead Pump to the last Lag Pump, the first Lag Pump to the Lead Pump, the second Lag Pump to the first Lag Pump, and so on. The alternation timer sets the accumulated run time (e.g., in hours) before the Lead Pump and the Lag Pumps will rotate. In certain embodiments, the alternation timer may be set for a range of hours from 1 to 168 hours. In certain embodiments, the default alternation timer is 24 hours. The alternation timer setting on the Lead Pump sets the interval time for the overall system. In certain embodiments, the Easy mode does not permit the user to modify any multi-pump parameters. When the pumps 10 in the system are alternating, the status of the pumps 10 currently operating is displayed on a monitor screen of the application running on the smartphone 36. In certain embodiments, the role of the pumps 10 (i.e., Lead Pump or Lag Pump) may be changed by the user via the application.

In certain embodiments, the Advanced mode setup for the Multidrive feature also assigns a Lead Pump designation to the first pump 10 put into the Multidrive setup mode. As additional pumps 10 are added to the system, they are designated Lag/Standby Pumps. In the Advanced mode, the user must identify the role of each pump 10 after the Lead Pump as either a Lag Pump or a Standby Pump. Additionally, the user must either enable or disable the alternation mode of operation described above. One or more Standby Pumps may serve as spares to replace a Lead Pump or a Lag Pump in a faulty or deactivated condition and are added at the end of the sequence of pumps 10. In certain embodiments, all of the pumps 10 in the system are included in the alternation mode. In the Advanced mode setup, the Lead Pump sets the water pressure setpoint and the drawdown pressure setpoint for all pumps 10 in the system. In certain embodiments, the Lead Pump sets the water pressure setpoint for each Lag Pump to a value that is less than or equal to the water pressure setpoint of the Lead Pump. In certain embodiments, the Lead Pump sets the drawdown pressure of all pumps 10 in the system to the same value. The Lead Pump may also set the alternation timer, the Lag Pump start/stop speed, and the timer delays for all pumps 10.

In certain embodiments, when the user activates the Multidrive feature, the processor 23 may cause the interface 22 to display Multidrive options including “Easy mode,” “Advanced mode,” “Join network,” “Edit setup,” and “Leave network” as is further described below. In certain embodiments, the default option is “Leave network.” In certain embodiments, if a pump 10 is not already connected in a multi-pump system, then the processor 23 may cause the interface 22 to only display the “Easy mode,” “Advanced mode” and “Join network” Multidrive options. If a pump 10 is already part of a multi-pump system, then in the Easy mode setup the Multidrive options will include only “Leave network.” In the Advanced mode setup, however, the Multidrive options of “Edit setup” and “Leave network” will be displayed.

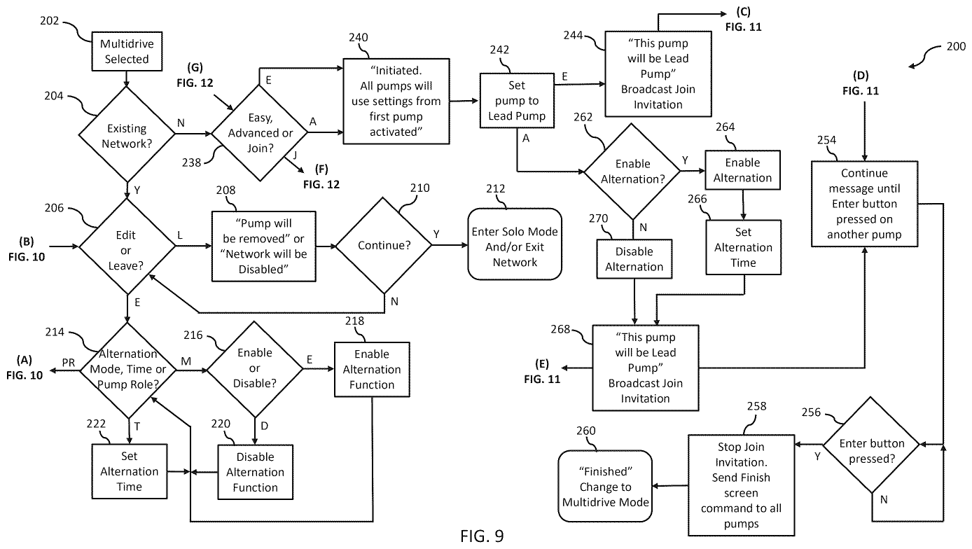

Referring now to FIGS. 9-12, a process 200 for configuring the Multidrive feature of the present disclosure is shown. The process 200 begins at block 202 when the user selects Multidrive from a performance features menu of the pump 10. At block 204, the processor 23 causes the interface 22 to display the question of whether the user would like to use an existing network. If so, then the processor 23 causes the interface 22 to display the options of editing the setup of an existing network or leaving the existing network. If the user selects the leave option, then at block 208 the processor 23 causes the interface 22 to display a message such as “This pump will be removed from the Multidrive network.” Additionally, if the pump is the Lead Pump, then the processor 23 will also cause the interface 22 to display a message such as “The Multidrive network will be disabled.” Then, at block 210, the processor 23 causes the interface 22 to display the options of continuing or not continuing. If the user selects the continue option, then at block 212 the processor 23 sets the pump 10 to operate in solo mode and/or exits the Multidrive network. The interface 22 may then display the performance features menu mentioned above. If, at block 210, the user selects the option of not continuing, then the process 200 returns to block 206 where the user is provided the options of editing or leaving the existing network.

If the user selects the edit existing network option, then the processor 23 causes the interface 22 to display the options of alternation mode, alternation time, and pump role at block 214. If the user selects the alternation mode option, then at block 216 the processor 23 causes the interface 22 to display the options of enable and disable. If the user selects the enable option, then at block 218 the processor 23 enables the alternation function and the process 200 returns to block 214 where the user may exit the process by pressing the back button 72. If the user selects the disable option, then at block 220 the processor 23 disables the alternation function, all pumps in the network maintain their current roles and the process 200 returns to block 214. If, at block 214, the user selects the alternation time option, then at block 222 the processor 23 causes the interface 22 to interact with the user to set the alternation time and the process returns to block 214.

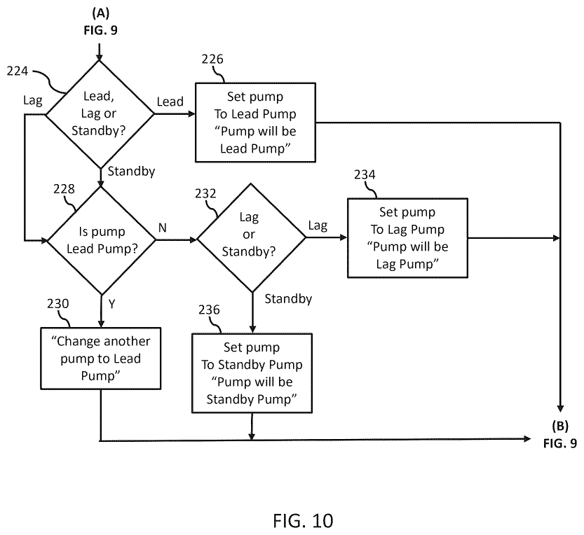

If the user selects the pump role option at block 214, then the process 200 moves to block 224 of FIG. 10. At block 224, the processor 23 causes the interface 22 to display the options of Lead Pump, Lag Pump and Standby Pump. If the user selects the Lead Pump option, then at block 226 the processor 23 assigns the Lead Pump role to the current pump 10 and changes the previous Lead Pump to a Lag Pump. The processor 23 may also cause the interface 22 to display a message such as “Pump will be set to Lead Pump. Previous Lead Pump will be set to a Lag Pump.” The process 200 then returns to block 206 of FIG. 9.

If instead the user selects the Lag Pump of Standby Pump options at block 224, at block 228, then the processor 23 determines whether the current pump 10 is assigned the Lead Pump role. If so, then at block 230 the processor 23 causes the interface 22 to display a message such as “This pump is the current Lead Pump. Change another pump to Lead Pump to change this pump.” The process 200 then returns to block 206 of FIG. 9. If the processor 23 determines at block 228 that the current pump 10 is not assigned the Lead Pump role, then at block 232 the processor 23 causes the interface 22 to display a Lag Pump option and a Standby Pump option. If the user selects the Lag Pump option, then at block 234 the processor 23 sets the pump 10 to the next Lag Pump and causes the interface 22 to display a message such as “Pump will be set to Lag Pump (N).” The processor 23 may also reassign the Standby Pumps in order as needed. Then, the process 200 returns to block 206 of FIG. 9. If the user selects the Standby Pump option at block 232, then at block 236 the processor 23 sets the pump 10 to the next Standby Pump and causes the interface 22 to display a message such as “Pump will be set to Standby Pump (N).” The processor 23 may also reassign the Lag Pumps in order as needed. Then, the process 200 returns to block 206 of FIG. 9.

Referring back to FIG. 9, if at block 204 the user indicates that the network is not an existing network, then at block 238 the processor 23 causes the interface 22 to display the options of setting up a Multidrive network in the Easy mode or the Advanced mode, or joining a network. If the user selects either the Easy mode option or the Advanced mode option, then at block 240 the processor 23 causes the interface 22 to display a message such as “Multidrive network setup initiated. All pumps will use settings from the first pump activated.” Then, at block 242, the processor 23 assigns the Lead Pump role to the current pump 10. If the user selected the Easy mode at block 238, then at block 244 the processor 23 causes the interface 22 to display a message such as “This pump will be the Lead Pump. Next activate the next pump.” The processor 23 also causes the communication circuit 27 to broadcast an invitation to all other pumps 10 within Bluetooth range to join the Multidrive network.

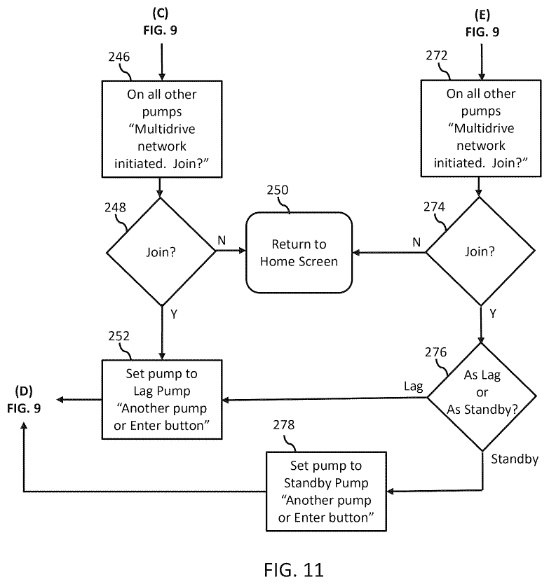

As indicated by block 246 of FIG. 11, the processors 23 of all other pumps 10 within Bluetooth range of the current pump 10 cause the interfaces 22 to display a message such as “Multidrive network initiated. Do you want this pump to join the Multidrive network?” Then, at block 248 the processors 23 cause the interfaces 22 to display the option of joining the network or not joining the network. If the user of one of the pumps 10 within range selects the option of not joining the network, then at block 250 the processor 23 of that pump 10 causes the interface to display the Home screen. On the other hand, if the user selects the join network option, then at block 252 the processor 23 assigns the pump 10 the Lag Pump role and causes the interface 22 to display a message such as “This pump will be Lag Pump (N). Next activate the next pump. If this is the last pump to be activated, press the Enter button.” Next, the process 200 moves to block 254 of FIG. 9 where the processor 23 causes the interface 22 to continue displaying such a message until the Enter button 74 is depressed on one of the interfaces 22 of another pump 10. When the processor 23 determines at block 256 that an Enter button 74 is pressed on another pump 10, then at block 258 the processor 23 of the Lead Pump stops broadcasting the join network invitation and causes the communication circuit 27 to send a command to all pumps 10 in the network to proceed to a Finish screen. Then, at block 260 the processor 23 causes the interface 22 to display a message such as “Multidrive setup is finished.” The processor 23 also causes the interface 22 to display the Home screen and changes the pump 10 to the Multidrive operation mode.

If the user selected the Advanced mode at block 238, then the process 200 advances from block 242 to block 262 where the processor 23 causes the interface 22 to present the user with options of enabling alternation or not enabling alternation. If the user selects the enable option, then at block 264 the processor 23 enables the alternation feature. Then, at block 266 the processor 23 causes the interface 22 to interact with the user to set the alternation time. If the user selects the option of not enabling alternation at block 262, then at block 270 the processor 23 disables the alternation feature. At block 268, the processor 23 causes the interface 22 to display a message such as “This pump will be the Lead Pump. Next activate the next pump.” The processor 23 also causes the communication circuit 27 to broadcast an invitation to all other pumps 10 within Bluetooth range to join the Multidrive network.

As indicated by block 272 of FIG. 11, the processors 23 of all other pumps 10 within Bluetooth range of the current pump 10 cause the interfaces 22 to display a message such as “Multidrive network initiated. Do you want this pump to join the Multidrive network?” Then, at block 274 the processors 23 cause the interfaces 22 to display the option of joining the network or not joining the network. If the user of one of the pumps 10 within range selects the option of not joining the network, then at block 250 the processor 23 of that pump 10 causes the interface 22 to display the Home screen. On the other hand, if the user selects the join network option, then at block 276 the processor 23 causes the interface 22 to display the options of joining as a Lag Pump, joining as a Standby Pump, or not joining the network. If the user selects the option of joining the network as a Lag Pump, then at block 252 the processor 23 assigns the Lag Pump role to the pump 10 and causes the interface 22 to display a message such as “This pump will be Lag Pump (N). Next activate the next pump. If this is the last pump to be activated, press the Enter button.” If, on the other hand, the user selects the option of joining the network as a Standby Pump at block 276, then at block 278 the processor 23 assigns the Standby Pump role to the pump 10 and causes the interface 22 to display a message such as “This pump will be Standby Pump (N). Next activate the next pump. If this is the last pump to be activated, pressure the Enter button.” Whether the user selects the Lag Pump or the Standby Pump option, after blocks 252 and 278 the process 200 returns to block 254 of FIG. 9.

At block 254 of FIG. 9 the processor 23 causes the interface 22 to continue displaying such a message until the Enter button 74 is depressed on one of the interfaces 22 of another pump 10. When the processor 23 determines at block 256 that an Enter button 74 is pressed on another pump 10, then at block 258 the processor 23 of the Lead Pump stops broadcasting the join network invitation and causes the communication circuit 27 to send a command to all pumps 10 in the network to proceed to a Finish screen. Then, at block 260 the processor 23 causes the interface 22 to display a message such as “Multidrive setup is finished.” The processor 23 also causes the interface 22 to display the Home screen and changes the pump 10 to the Multidrive operation mode.

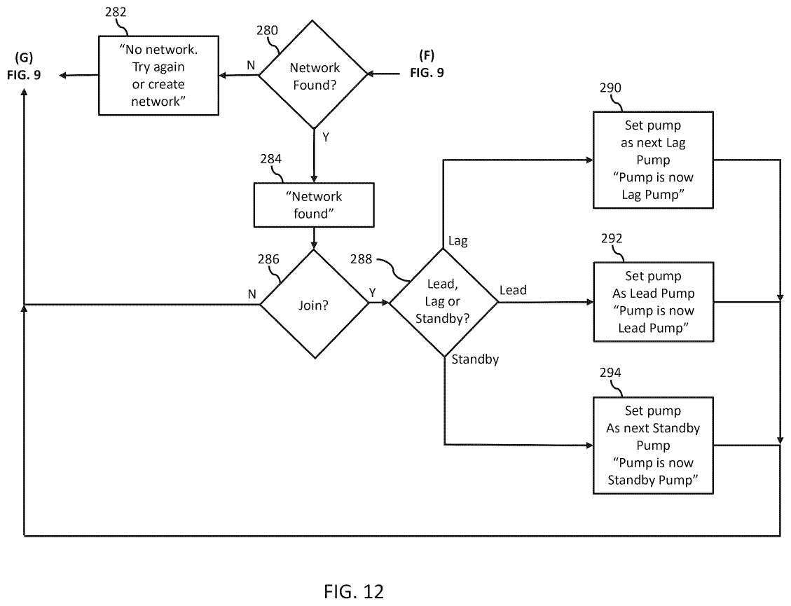

Referring back to block 238 of FIG. 9, if the user selects the join network option, the process 200 advances to block 280 of FIG. 12. At block 280, the processor 23 causes the communication circuit 27 to check for an existing network. If no network is found, then at block 282 the processor 23 causes the interface 22 to display a message such as “No network is found. Try again or create a new network.” Then, the process 200 returns to block 238 of FIG. 9. If, on the other hand, the communication circuit 27 finds an existing network, then at block 284 the processor 23 causes the interface 22 to display a message such as “Multidrive network found. Do you want this pump to join the network?” At block 286 the processor 23 causes the interface 22 to present the user with the option of joining the network or not joining the network. If the user selects the option of not joining the network, then the process 200 returns to block 238 of FIG. 9. If, on the other hand, the user selects the join network option, then at block 288 the processor 23 causes the interface 22 to present the user with the options of joining the network as a Lead Pump, a Lag Pump or a Standby Pump. If the user selects the Lag Pump option, then at block 290 the processor 23 assigns the Lag Pump role to the pump 10 and causes the interface 22 to display a message such as “Connected to network successfully. Pump is now Lag Pump (N). Multidrive settings are copied from the Lead Pump.” If the user selects the Lead Pump option at block 288, then at block 292 the processor 23 assigns the Lead Pump role to the pump 10 and causes the interface 22 to display a message such as “Connected to network successfully. Pump is now the Lead Pump. Multidrive settings are copied from this pump.” If the user selects the Standby Pump option at block 288, then at block 294 the processor 23 assigns the Standby Pump role to the pump 10 and causes the interface 22 to display a message such as “Connected to network successfully. Pump is now Standby Pump (N). Multidrive settings are copied from the Lead Pump.” Regardless of which option the user selects at block 288, after one of the messages of blocks 290, 292 or 294 are displayed, the process 200 returns to block 238 of FIG. 9.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A method of controlling a water pressure booster pump, comprising:
detecting, by a processor, a presence or an absence of flow data provided by a flow sensor in flow communication with an outlet of the pump;
determining, by the processor in response to detecting a presence of flow data, whether the flow data is greater than zero, indicating a demand of water from the pump;
responding, by the processor, to a determination that the flow data is not greater than zero, indicating no demand of water from the pump, by entering a sleep mode of operation wherein the processor causes a pump/motor assembly (“PMA”) of the pump to discontinue operation.

2. The method of claim 1, further comprising:
determining, by the processor when in the sleep mode of operation, whether the flow data is greater than zero, indicating a demand of water from the pump; and
responding, by the processor, to a determination that the flow data is greater than zero by exiting the sleep mode of operation wherein the processor controls the PMA to provide water at a substantially constant pressure according to a pressure setpoint.

3. The method of claim 1, further comprising:
determining, by the processor in response to detecting an absence of flow data, whether pressure data provided by a pressure sensor in flow communication with the outlet of the pump indicates a pressure of water at the outlet that is less than a pressure threshold;
controlling, by the processor, the PMA to provide water at a first pressure setpoint for a first time period, then controlling, by the processor, the PMA to provide water at a second, higher pressure setpoint for a second time period; and
causing, by the processor, the pump to enter the sleep mode of operation in response to a frequency of operation of the PMA remaining below a frequency threshold for a third time period during the controlling step.

4. The method of claim 3, wherein the frequency of operation of the PMA is a frequency of operation of a variable frequency drive of a motor section of the PMA.

5. The method of claim 1, wherein determining, by the processor in response to detecting a presence of flow data whether the flow data is greater than zero is performed by the processor periodically.

6. A method of controlling a water pressure booster pump, comprising:
providing, via a first interface of a first pump, a network option enabling a user to establish a first pump network through interaction with the first interface;
responding to the user selecting the network option by designating the first pump a lead pump role;
responding to the user selecting the network option by broadcasting, via a communication circuit of the first pump, an invitation option to at least one second pump within range of the communication circuit to join the first pump network;
providing, via an interface of the at least one second pump, a join option enabling the user to cause the at least one second pump to join the pump network;
responding to the user selecting the join option by designating the at least one second pump a lag pump role; and
controlling the first pump and the at least one second pump to operate together to provide pressurized water to at least one water consuming device.

7. The method of claim 6, further comprising:
providing, via the first interface, an alternation option enabling the user to selection an alternation mode of operation of the first pump and the at least one second pump; and
responding to the user selecting the alternation option by causing the first pump and the at least one second pump to alternate operation.

8. The method of claim 7, further comprising:
providing, via the first interface, an alternation timer option enabling the user to select, via the first interface, an alternation timer for alternating operation of the first pump and the at least one second pump.

9. The method of claim 6, further comprising:
providing, via the first interface, an edit option enabling the user to edit parameters of an existing pump network; and
responding to the user selecting the edit option by providing, via the first interface, an alternation mode option, an alternation time option and a pump role option.

10. The method of claim 9, further comprising:
responding to the user selecting the alternation mode option by providing the user an enable option and a disable option;
responding to the user selecting the enable option by enabling an alternation mode of operation for pumps connected on the existing pump network; and
responding to the user selecting the disable option by disabling the alternation mode of operation.

11. The method of claim 9, further comprising:
responding to the user selecting the alternation timer option by enabling the user to select, via the first interface, an alternation timer for alternating operation of pumps connected on the existing pump network.

12. The method of claim 9, further comprising:
responding to the user selecting the pump role option by providing the user a lead pump role option, a lag pump role option and a standby pump role option.

13. The method of claim 12, further comprising:
responding to the user selecting the lead pump role option by designating the first pump the lead pump role in the existing network.

14. The method of claim 12, further comprising:
responding to the user selecting either of the lag pump role option or the standby pump role option by prompting the user to indicate whether the first pump currently has a lead pump designation.

15. The method of claim 14, further comprising:
responding to an indication from the user that the first pump currently has the lead pump designation by prompting the user to change a designation of another pump in the existing pump network to the lead pump designation.

16. The method of claim 14, further comprising:
responding to an indication from the user that the first pump does not currently have the lead pump designation by prompting the user to select a lag pump designation for the first pump or a standby pump designation for the first pump;
responding to the user selecting the lag pump designation by designating the first pump a lag pump role; and
responding to the user selecting the standby pump designation by designating the first pump a standby pump role.

17. A method of controlling a water pressure booster pump, comprising:
enabling a user to specify a future time period during which a processor controlling operation of a pump/motor assembly (“PMA”) of the pump causes a change in the operation of the PMA;
enabling the user to specify the change in the operation of the PMA as one of operating the PMA at a temporary pressure setpoint or stopping operation of the PMA;
controlling, by the processor, the operation of the PMA at an original pressure setpoint until a start time of the future time period occurs;
controlling, by the processor, the operation of the PMA according to the user-specified change in operation of the PMA when the start time of the future time period occurs; and
controlling, by the processor, the operation of the PMA at an original pressure setpoint when a stop time of the future time period occurs.

18. The method of claim 17, wherein enabling the user to specify the future time period includes enabling the user to select via an interface of the pump the start time including a start year, a start month and a start day, and the stop time including a stop year, a stop month and a stop day.

19. The method of claim 18, further comprising determining, by the processor, whether the start time is before the stop time.

20. The method of claim 17, wherein enabling the user to specify the future time period includes enabling the user to select via an interface of the pump a number of days beginning with a current day.

21. The method of claim 17, wherein enabling the user to specify the change in the operation of the PMA includes enabling the user to specify that the temporary pressure setpoint for the PMA during the future time period will be a minimum pressure setpoint.

22. The method of claim 17, further comprising monitoring, by the processor, a demand for water during the future time period and transmitting a message via a communication circuit of the pump to the user in response to the demand exceeding the reduced pressure setpoint.

23. The method of claim 17, further comprising enabling the user to specify that the future time period corresponds to at least one scheduled event that occurs each week.

24. The method of claim 17, wherein enabling the user to specify the future time period includes enabling the user to select via an interface of the pump the start time including a start time of day and an end time of day.

25. The method of claim 17, wherein enabling the user to specify the change in the operation of the PMA includes enabling the user to specify that the temporary pressure setpoint for the PMA during the future time period will be an increased pressure setpoint relative to the original pressure setpoint.

26. The method of claim 17, wherein enabling the user to specify a future time period includes enabling the user to specify a plurality of future time periods, each future time period corresponding to at least one time period during each of a plurality of consecutive weeks.
